(19) United States
(12) Patent Application Publication
(10) Pub. No.: US 2026/0274593 A1
(43) Pub. Date: Sep. 17, 2026

(54) ELECTRODE ASSEMBLY GRIPPER AND ELECTRODE ASSEMBLY TRANSPORT SYSTEM

(71) Applicant: SK On Co., Ltd., Seoul (KR)

(72) Inventors: Seong In JI, Daejeon (KR); Chi Hyun KIM, Daejeon (KR)

(21) Appl. No.: 19/458,932

(22) Filed: Jan. 26, 2026

(30) Foreign Application Priority Data
Mar. 17, 2025 (KR) 10-2025-0033913

(51) Int. Cl. B65G 47/90; H01M 10/04

(52) U.S. Cl. CPC B65G 47/907; H01M 10/0404

(57) ABSTRACT

An electrode assembly gripper is disclosed. In some implementations, the gripper includes: a first gripper on which an electrode assembly is disposed; a second gripper disposed to face the first gripper; and a main body including a support portion supporting the first gripper and the second gripper, and a moving portion capable of relatively moving at least one of the first gripper and the second gripper, wherein the second gripper includes a gripper base connected to the main body, a contact portion capable of being in contact with the electrode assembly, and a hinge part providing a rotational motion to the contact portion.

### CROSS-REFERENCE TO RELATED APPLICATIONS

This patent document claims the priority and benefits of Korean Patent Application No. 10-2025-0033913 filed on March 17, 2025, the disclosure of which is incorporated herein by reference in its entirety.

### TECHNICAL FIELD

The disclosure and implementations disclosed in this patent document generally relate to an electrode assembly gripper and an electrode assembly transport system including the same.

### BACKGROUND

Unlike a primary battery, a secondary battery has the convenience of being chargeable and dischargeable, and thus has received significant attention as a power source for various mobile devices, electric vehicles, or the like.

Such a secondary battery may include a battery cell in which an electrode assembly is accommodated in a case, the electrode assembly being formed by stacking or winding in a roll form a positive electrode plate, a negative electrode plate, and a separator. The plurality of battery cells may be stacked in a predetermined direction and accommodated in a battery module or a battery pack.

### SUMMARY

During a manufacturing process of a secondary battery, if an electrode assembly is not uniformly gripped by a gripper, the electrode assembly may be separated from the gripper or electrode plates of the electrode assembly may be misaligned.

The present disclosure may be implemented in some embodiments to provide an electrode assembly gripper and an electrode assembly transport system including the same, in which misalignment of electrode plates of an electrode assembly during the manufacturing process of a secondary battery is prevented.

The present disclosure may be implemented in some embodiments to provide an electrode assembly gripper and an electrode assembly transport system including the same, in which separation of an electrode assembly from a gripper during the manufacturing process of a secondary battery is prevented.

An electrode assembly gripper and an electrode assembly transport system including the same according to the present disclosure may be widely applied to devices within green technology fields such as electric vehicles and battery charging stations, as well as solar power generation or wind power generation utilizing batteries. In addition, the electrode assembly gripper and an electrode assembly transport system including the same according to the present disclosure may be used for eco-friendly electric vehicles (EVs), hybrid vehicles, and the like for preventing climate change by suppressing air pollution and greenhouse gas emissions.

In some embodiments of the present disclosure, an electrode assembly gripper includes: a first gripper on which an electrode assembly is disposed; a second gripper disposed to face the first gripper; and a main body including a support portion supporting the first gripper and the second gripper, and a moving portion capable of relatively moving at least one of the first gripper and the second gripper, wherein the second gripper includes a gripper base connected to the main body, a contact portion capable of being in contact with the electrode assembly, and a hinge part providing a rotational motion to the contact portion.

The hinge part may include a first through-hole formed in the gripper base, a second through-hole formed in the contact portion, and a hinge pin passing through the first through-hole and the second through-hole.

The gripper base may include a groove part providing a space in which the contact portion is disposed.

Each of the first gripper and the gripper base may include a C-shaped configuration.

The first gripper may include first bars disposed to be spaced apart from each other, and the gripper base may include second bars disposed to be spaced apart from each other.

The hinge part may be positioned in a central region of the second bars.

A length of the first bar and a length of the contact portion may each be greater than or equal to a length of the electrode assembly.

The second gripper may further include an elastic part disposed between the gripper base and the contact portion to provide elastic force to the contact portion.

The elastic part may include a plurality of elastic parts, and the plurality of elastic parts may be symmetrically arranged with respect to the hinge part.

The gripper may further include a friction part disposed on one surface of the contact portion and providing a greater frictional force to the electrode assembly than the contact portion.

In some embodiments of the present disclosure, an electrode assembly transport system includes: a first gripper on which an electrode assembly is disposed; a second gripper disposed to face the first gripper; a main body including a support portion supporting the first gripper and the second gripper, and a moving portion capable of relatively moving at least one of the first gripper and the second gripper; and a transport part receiving the electrode assembly from the first gripper and the second gripper and transporting the electrode assembly, wherein the second gripper includes a gripper base connected to the main body, a contact portion capable of being in contact with the electrode assembly, and a hinge part connecting the gripper base to the contact portion.

The transport part may include a lower plate on which the electrode assembly is disposed and an upper plate gripping the electrode assembly together with the lower plate while the electrode assembly is positioned therebetween.

A width of the lower plate may be greater than a width of the first gripper or a width of the electrode assembly.

The lower plate may include at least one lifting part structured to move in a direction toward the electrode assembly.

The at least one lifting part may include a plurality of lifting parts, and the plurality of lifting parts may be symmetrically arranged with respect to a center line of the lower plate in a width direction.

The first gripper may include first bars disposed to be spaced apart from each other, and the plurality of lifting parts may include a first lifting part positioned between the first bars and a second lifting part positioned outside the first bars.

### BRIEF DESCRIPTION OF DRAWINGS

Certain aspects, features, and advantages of the present disclosure are illustrated by the following detailed description with reference to the accompanying drawings.

FIG. 1 is a perspective view of an electrode assembly gripper according to an embodiment.

FIGS. 2A and 2B are side views of the electrode assembly gripper according to various embodiments.

FIGS. 3A and 3B are cross-sectional views taken along line I-I′ or line II-II′ of FIG. 1.

FIG. 4 is a cross-sectional view taken along line III-III′ of the electrode assembly gripper according to an embodiment.

FIGS. 5A to 5C are schematic views illustrating an operation process of the electrode assembly gripper according to an embodiment.

FIGS. 6A to 6C are schematic views illustrating an operation process of the electrode assembly gripper according to an embodiment.

FIGS. 7A to 7D are schematic views illustrating an operation process of an electrode assembly transport system according to an embodiment.

FIG. 8 is a plan view of the electrode assembly transport system according to an embodiment as viewed from above, in which a second gripper is omitted.

FIG. 9 is a plan view of the electrode assembly transport system according to an embodiment as viewed from above, in which a second gripper is omitted.

### DETAILED DESCRIPTION

Features of the present disclosure disclosed in this patent document are described by example embodiments with reference to the accompanying drawings.

The present disclosure may be implemented in some embodiments to provide an electrode assembly gripper and an electrode assembly transport system including the same.

In the specification, the same reference numerals or signs described or illustrated in the accompanying drawings denote parts or components that perform substantially the same functions. For convenience of description and understanding, the same reference numerals or signs may be used for description even in different embodiments. That is, even if components having the same reference numerals are illustrated in the plurality of drawings, the plurality of drawings do not necessarily refer to one embodiment.

In the following description, a term of a singular number includes its plural number unless clearly indicated otherwise in the context. Terms such as “include” or “comprise” are intended to specify the presence of features, numbers, steps, operations, components, parts, or combinations thereof described in the specification, and are not intended to preclude the possibility of presence or addition of one or more other features, numbers, steps, operations, components, parts, or combinations thereof.

In addition, in the following description, expressions such as upper side, upper portion, lower side, lower portion, side, front, and rear are expressed based on the directions illustrated in the drawings, and it is previously stated that such an expression may be expressed differently if a direction of the corresponding subject is changed.

In addition, in the following description and claims, terms including ordinals such as “first” and “second” may be used for distinction among components. Such ordinals are used to distinguish the same or similar components from each other, and should not be construed to limit meanings of terms due to the use of such ordinal numbers. For example, components coupled with such ordinals should not be construed to be limited in use order or arrangement order by the numerals. If necessary, the respective ordinals may be interchanged and used.

Hereinafter, the present disclosure is described in detail with reference to the drawings. However, the present disclosure is merely illustrative, and is not limited to the specific embodiments illustratively described.

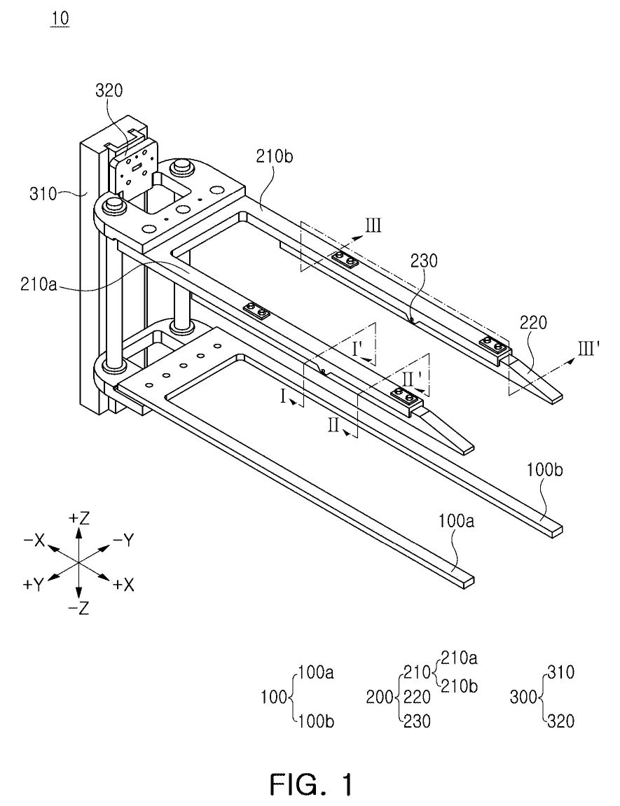

FIG. 1 is a perspective view of an electrode assembly gripper 10 according to an embodiment.

Referring to FIG. 1, the electrode assembly gripper 10 according to an embodiment of the present disclosure may include: a first gripper 100 on which an electrode assembly 1000 is disposed; a second gripper 200 disposed to face the first gripper 100; and a main body 300 including a support portion 310 supporting the first gripper 100 and the second gripper 200, and a moving portion 320 capable of relatively moving at least one of the first gripper 100 and the second gripper 200.

According to an embodiment, when viewed from above or below, the first gripper 100 may include a C-shaped configuration. That is, the first gripper 100 may include an opening.

According to an embodiment, the first gripper 100 may include first bars 100a and 100b disposed to be spaced apart from each other. Each of the first bars 100a and 100b may have a shape extending in a first direction. The first direction may correspond to an X-axis direction in an XYZ coordinate system. The pair of first bars 100a and 100b may be provided. The first bars 100a and 100b may be disposed to be parallel to each other. The first bars 100a and 100b disposed to be parallel to each other may stably support the electrode assembly 1000.

The first bars 100a and 100b may be disposed to be spaced apart from each other in a second direction perpendicular to the first direction. Accordingly, the opening may be formed between the first bars 100a and 100b. The second direction may correspond to a Y-axis direction in the XYZ coordinate system.

According to an embodiment, when viewed from above or below, the second gripper 200 may include a C-shaped configuration. That is, the second gripper 200 may include an opening.

According to an embodiment, the second gripper 200 may include second bars 210a and 210b disposed to be spaced apart from each other. Each of the second bars 210a and 210b may have a shape extending in the first direction. The pair of second bars 210a and 210b may be provided. The second bars 210a and 210b may be disposed to be parallel to each other.

The second bars 210a and 210b may be disposed to be spaced apart from each other in the second direction. Accordingly, the opening may be formed between the second bars 210a and 210b.

The second gripper 200 may be disposed to face the first gripper 100. Accordingly, the electrode assembly 1000 may be disposed between the first gripper 100 and the second gripper 200, and the first gripper 100 and the second gripper 200 may grip the electrode assembly 1000.

The first gripper 100 and the second gripper 200 may be disposed to be spaced apart from each other in a third direction. At least one of the first gripper 100 and the second gripper 200 may move along the third direction to grip the electrode assembly 1000. The third direction may correspond to a Z-axis direction in the XYZ coordinate system.

The main body 300 may include the support portion 310 supporting the first gripper 100 and the second gripper 200, and the moving portion 320 capable of relatively moving at least one of the first gripper 100 and the second gripper 200.

The moving portion 320 may be connected to the second gripper 200. The moving portion 320 may move in the third direction. That is, the moving portion 320 may move the second gripper 200 in the third direction.

For example, the moving portion 320 may be provided in the form of a cylinder structure using hydraulic pressure or pneumatic pressure, or a structure including a motor and a ball screw converting a rotational motion of the motor into a linear motion. The moving portion 320 may move along a guide. However, the moving portion 320 is not limited thereto, and may be appropriately selected in consideration of a manufacturing environment.

The moving portion 320 is not limited to being connected to the second gripper 200 to move the second gripper 200, and may also be connected to the first gripper 100 to move the first gripper 100. Alternatively, the moving portion 320 may be connected to both the first gripper 100 and the second gripper 200 to move both the first gripper 100 and the second gripper 200. That is, the moving portion 320 may relatively move at least one of the first gripper 100 and the second gripper 200.

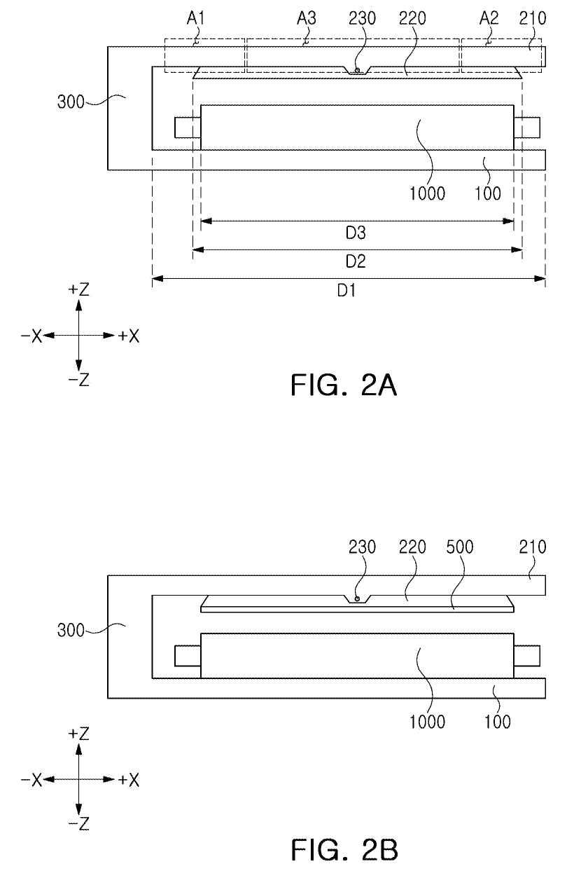

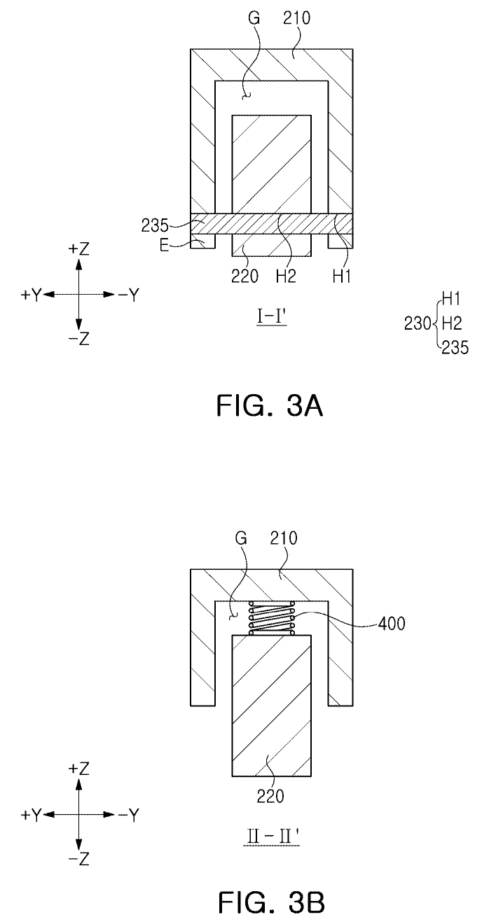

FIGS. 2A and 2B are side views of the electrode assembly gripper 10 according to various embodiments. FIGS. 3A and 3B are cross-sectional views taken along line I-I′ or line II-II′ of FIG. 1.

The descriptions of the first gripper 100, the second gripper 200, and the main body 300 in FIG. 1 may also be applied to the first gripper 100, the second gripper 200, and the main body 300 in FIG. 2, and may also be applied to the first gripper 100 and the second gripper 200 in FIG. 3.

Referring to FIG. 2A together with FIG. 3A, according to an embodiment, the second gripper 200 may include a gripper base 210 connected to the main body 300, a contact portion 220 capable of being in contact with the electrode assembly 1000, and a hinge part 230 providing a rotational motion to the contact portion 220. The gripper base 210 may include second bars 210a and 210b disposed to be spaced apart from each other.

According to an embodiment, the hinge part 230 may include a first through-hole H1 formed in the gripper base 210, a second through-hole H2 formed in the contact portion 220, and a hinge pin 235 passing through the first through- hole H1 and the second through-hole H2.

The hinge pin 235 may pass through the first through-hole H1 and the second through-hole H2 to fix the contact portion 220 and the gripper base 210 around an axis of the hinge pin 235. The hinge pin 235 may provide a rotational motion to the contact portion 220 around the axis of the hinge pin 235. That is, a rotational motion axis of the contact portion 220 may correspond to the axis of the hinge pin 235.

Each of the second bars 210a and 210b may include a first region A1 adjacent to the moving portion 320, a second region A2 adjacent to an end of the second bar, and a central region A3 disposed between the first region A1 and the second region A2. According to an embodiment, the hinge part 230 may be positioned in the central region A3 of the second bars 210a and 210b. The hinge pin 235 may be positioned in the central region A3 of the second bars 210a and 210b. That is, the rotational motion axis of the contact portion 220 may be positioned in the central region A3 of each of the second bars 210a and 210b. Accordingly, the contact portion 220 may provide a uniform force to the electrode assembly 1000 and may stably grip the electrode assembly 1000.

According to an embodiment, a length D1 of the first bar 100a or 100b and a length D2 of the contact portion 220 may each be greater than or equal to a length D3 of the electrode assembly 1000. Accordingly, the electrode assembly 1000 may be stably disposed on the first gripper 100 and may be stably gripped by the contact portion 220.

According to an embodiment, the gripper base 210 may include a groove part G providing a space in which the contact portion 220 is disposed. In addition, the groove part G may provide a spatial margin to allow the contact portion 220 to perform the rotational motion. That is, the groove part G may not only provide the space in which the contact portion 220 is disposed, but also provide the spatial margin for the rotational motion, thereby allowing the electrode assembly 1000 to be gripped even in a case of parallelism mismatch between the first gripper 100 and the second gripper 200 or a thickness imbalance of the electrode assembly 1000.

According to an embodiment, the second gripper 200 may further include an elastic part 400 disposed between the gripper base 210 and the contact portion 220 to provide elastic force to the contact portion 220.

The elastic part 400 may be disposed between the gripper base 210 and the contact portion 220. For example, the elastic part 400 may be disposed in the groove part G. The elastic part 400 may be disposed in the groove part G to provide the elastic force to the contact portion 220, thereby allowing the contact portion 220 to grip the electrode assembly 1000. For example, the elastic part 400 may be provided as a spring.

According to an embodiment, the second gripper 200 may further include a friction part 500 disposed on one surface of the contact portion 220 and providing a greater frictional force to the electrode assembly 1000 than the contact portion 220.

One surface of the contact portion 220 may refer to its surface facing the electrode assembly 1000. In the drawing, the corresponding surface may refer to a surface of the contact portion 220 positioned on a -Z side.

The friction part 500 may be disposed on one surface of the contact portion 220 and in direct contact with the electrode assembly 1000. The friction part 500 may be made of a material having a great frictional force and provide the greater frictional force to the electrode assembly 1000 than the contact portion 220. For example, the friction part 500 may be provided as a foam sheet or the like. The friction part 500 may include polyurethane.

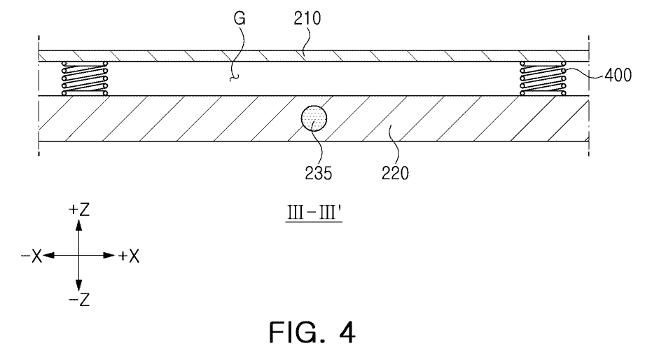

FIG. 4 is a cross-sectional view taken along line III-III′ of the electrode assembly gripper 10 according to an embodiment.

The descriptions of the first gripper 100, the second gripper 200, and the main body 300 of FIG. 1 may also be applied to the first gripper 100 and the second gripper 200 in FIG. 4.

According to an embodiment, the elastic part 400 may include a plurality of elastic parts 400, and the plurality of elastic parts 400 may be symmetrically arranged with respect to the hinge part 230.

The plurality of elastic parts 400 may be disposed in the groove part G. The plurality of elastic parts 400 may be symmetrically arranged in the groove part G with respect to the hinge part 230, thereby offsetting the parallelism mismatch between the first gripper 100 and the second gripper 200 and the thickness imbalance of the electrode assembly 1000 and stably gripping the electrode assembly 1000.

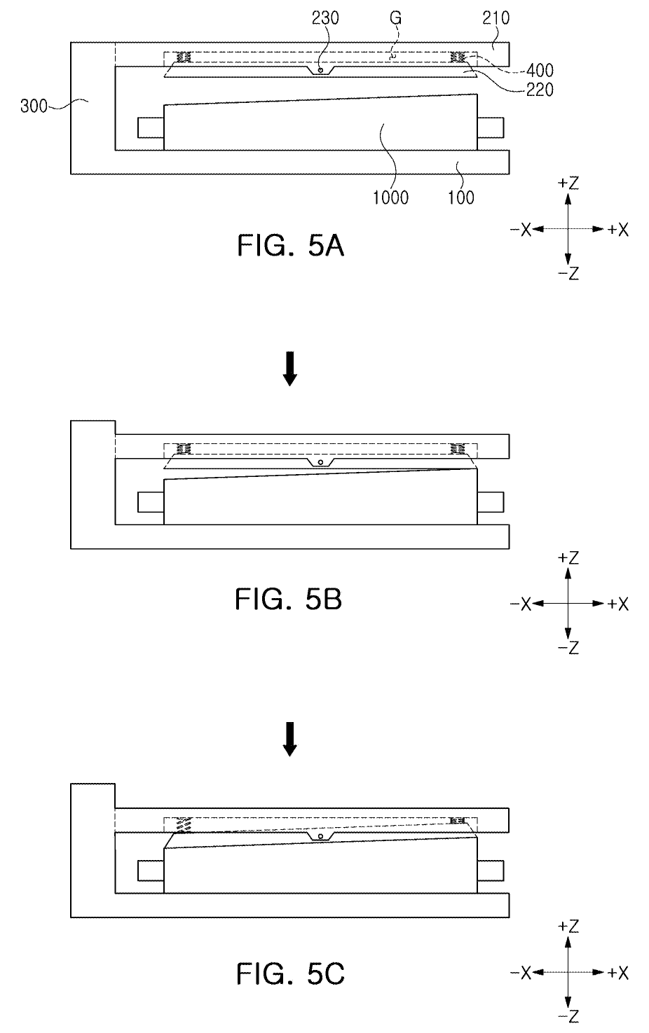

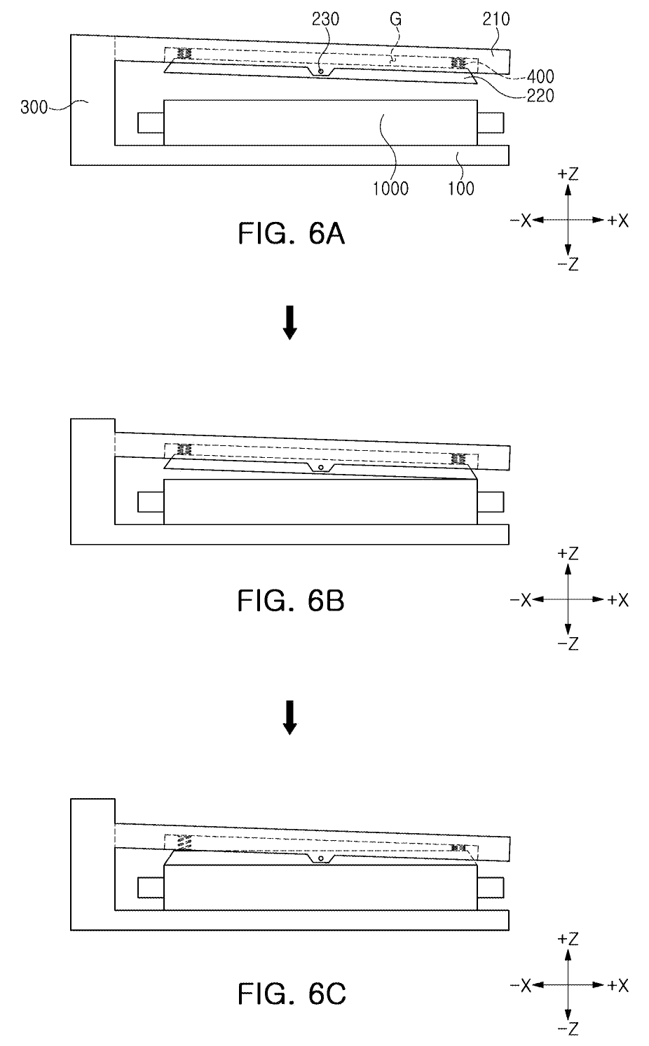

Specific operation mechanisms of the hinge part 230, the elastic part 400, and the contact portion 220 are described below with reference to FIGS. 5A to 5C and FIGS. 6A to 6C.

FIGS. 5A to 5C are schematic views illustrating an operation process of the electrode assembly gripper 10 according to an embodiment. FIGS. 6A to 6C are schematic views illustrating an operation process of the electrode assembly gripper 10 according to an embodiment.

The descriptions of the first gripper 100, the second gripper 200, and the main body 300 in FIG. 1 may also be applied to the first gripper 100, the second gripper 200, and the main body 300 in FIGS. 5A to 5C and FIGS. 6A to 6C.

FIGS. 5A to 5C illustrate a process in which the electrode assembly gripper 10 according to the present disclosure may grip the electrode assembly 1000 when a thickness of the electrode assembly 1000 is not uniform, and FIGS. 6A to 6C illustrate a process in which the electrode assembly gripper 10 according to the present disclosure grips the electrode assembly 1000 when the parallelism between the first gripper 100 and the second gripper 200 is misaligned.

Referring to FIGS. 5A and 6A, the electrode assembly 1000 may be disposed on the first gripper 100 to allow a length direction of the electrode assembly 1000 to be parallel to the first bars 100a and 100b. The thickness of the electrode assembly 1000 disposed on the first gripper 100 may not be uniform along the first direction (i.e., the X-axis direction). Alternatively, the parallelism of the first gripper 100 and the second gripper 200 may be misaligned.

Referring to FIGS. 5B and 6B, the second gripper 200 may move in a -Z direction. In detail, the second gripper 200 may be connected to the moving portion 320, and may move in the -Z direction together with the moving portion 320 as the moving portion 320 moves in the -Z direction.

As the second gripper 200 moves in the -Z direction, the contact portion 220 may come into contact with the electrode assembly 1000. If the thickness of the electrode assembly 1000 is not uniform or the parallelism between the first gripper 100 and the second gripper 200 is misaligned, the contact portion 220 may first come into contact with one side of the electrode assembly 1000.

Referring to FIGS. 5C and 6C, the second gripper 200 may move further in the -Z direction. As the second gripper 200 moves further in the -Z direction, one elastic part 400 may be compressed. In addition, the other elastic part 400 may be extended. That is, a thickness difference of the electrode assembly 1000 or the parallelism mismatch between the first gripper 100 and the second gripper 200 may be offset by the plurality of elastic parts 400 symmetrically arranged with respect to the hinge part 230.

As one elastic part 400 is compressed and the other elastic part 400 is extended, the contact portion 220 may entirely come into contact with the electrode assembly 1000 and stably grip the electrode assembly 1000.

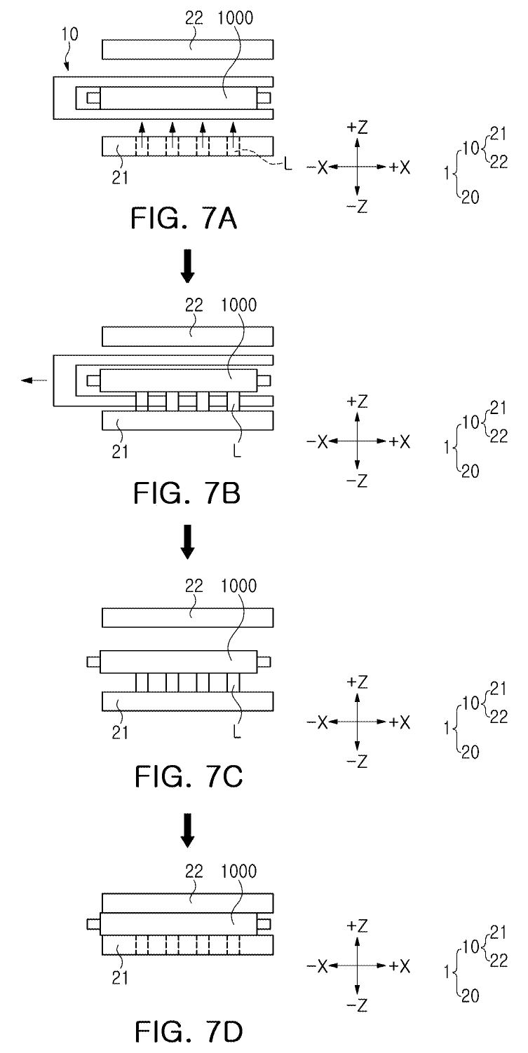

FIGS. 7A to 7D are schematic views illustrating an operation process of an electrode assembly transport system 1 according to an embodiment.

The descriptions of the electrode assembly gripper 10 in FIG. 1 may also be applied to the electrode assembly gripper 10 in FIG. 7.

Referring to FIG. 7A together with FIG. 1, according to an embodiment of the present disclosure, the electrode assembly transport system 1 may include: the first gripper 100 on which the electrode assembly 1000 is disposed; the second gripper 200 disposed to face the first gripper 100; the main body 300 including the support portion 310 supporting the first gripper 100 and the second gripper 200, and the moving portion 320 capable of relatively moving at least one of the first gripper 100 and the second gripper 200; and a transport part 20 receiving the electrode assembly 1000 from the first gripper 100 and the second gripper 200 and transporting the electrode assembly 1000. The second gripper 200 may include the gripper base 210 connected to the main body 300, the contact portion 220 capable of being in contact with the electrode assembly 1000, and the hinge part 230 connecting the gripper base 210 to the contact portion 220.

According to an embodiment, the transport part 20 may include a lower plate 21 on which the electrode assembly 1000 is disposed and an upper plate 22 gripping the electrode assembly 1000 together with the lower plate 21 while the electrode assembly 1000 is positioned therebetween.

The electrode assembly gripper 10 gripping the electrode assembly 1000 may move to the transport part 20 to deliver the electrode assembly 1000. Specifically, the electrode assembly gripper 10 may be positioned between the upper and lower plates 22 and 21 of the transport part 20.

According to an embodiment, the lower plate 21 includes at least one lifting part L structured to move in a direction toward the electrode assembly 1000. The lower plate 21 may include at least one lifting part L capable of moving in a direction perpendicular to one surface of the electrode assembly 1000.

The lifting part L may be provided in the form of a pin. When the electrode assembly gripper 10 is positioned between the upper plate 22 and the lower plate 21, the lifting part L may be in a state of being disposed inside the lower plate 21. At least one lifting part L disposed inside the lower plate 21 may protrude from the lower plate 21 toward the electrode assembly 1000 to support the electrode assembly 1000. The direction perpendicular to one surface of the electrode assembly 1000 may refer to a +Z direction in the drawings.

Referring to FIG. 7B, as the lifting part L protrudes, the second gripper 200 of the electrode assembly 1000 may move in the +Z direction. Accordingly, at least one lifting part L protruding from the lower plate 21 may support the electrode assembly 1000, and the electrode assembly 1000 may be separated from the first gripper 100 of the electrode assembly gripper 10.

The electrode assembly gripper 10 may be separated between the upper plate 22 and the lower plate 21. In the drawings, the electrode assembly gripper 10 may move in a -X direction. Here, the electrode assembly 1000 may be supported on at least one lifting part L.

Referring to FIG. 7C, at least one lifting part L may be disposed in the lower plate 21 while supporting the electrode assembly 1000. Accordingly, the electrode assembly 1000 supported on the lifting part L may be supported on the lower plate 21.

The upper plate 22 may move in a direction toward the electrode assembly 1000 together with the lower plate 21 to grip the electrode assembly 1000. Here, the direction toward the electrode assembly 1000 may refer to the -Z direction.

Referring to FIG. 7D, the upper plate 22 and the lower plate 21 may grip the electrode assembly 1000 together. The transport part 20 gripping the electrode assembly 1000 may transport the electrode assembly 1000 to a subsequent process.

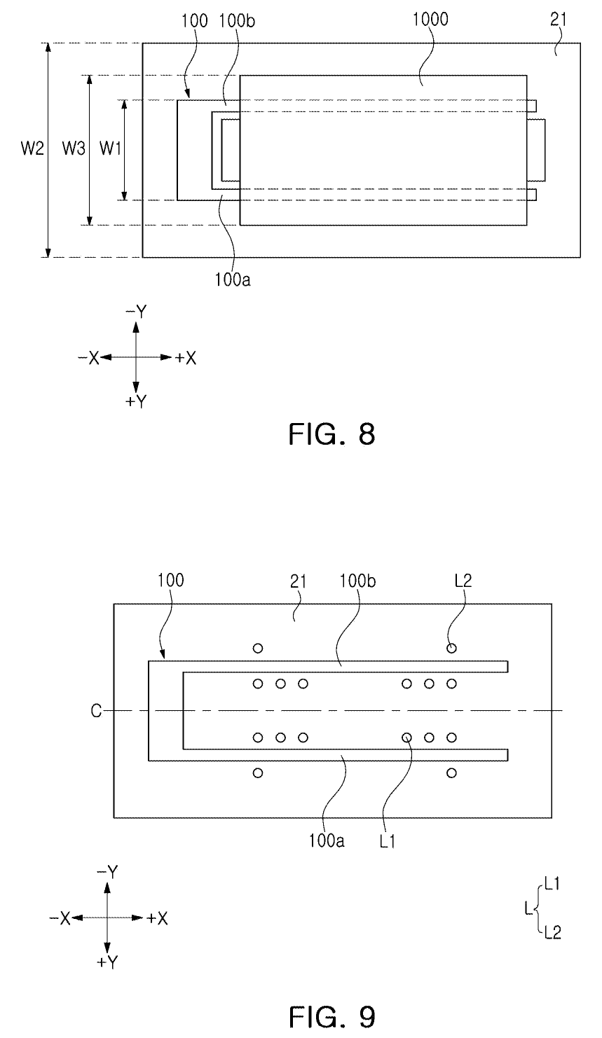

FIG. 8 is a plan view of the electrode assembly transport system 1 according to an embodiment as viewed from above, in which the second gripper 200 is omitted. FIG. 9 is a plan view of the electrode assembly transport system 1 according to an embodiment as viewed from above, in which the second gripper 200 is omitted.

The descriptions of the first gripper 100 in FIG. 1 and the lower plate 21 in FIG. 7 may also be applied to the first gripper 100 and lower plate 21 in FIGS. 8 and 9, respectively. Accordingly, the first gripper 100 may include the first bars 100a and 100b disposed to be spaced apart from each other.

Referring to FIGS. 8 and 9, according to an embodiment, at least one lifting part L may include a plurality of lifting parts L, and the plurality of lifting parts L may be symmetrically arranged with respect to a center line C of the lower plate 21 in a width direction (i.e., the Y-axis direction).

The center line C of the lower plate 21 in the width direction (i.e., the Y-axis direction) may be positioned at the center of the lower plate 21 in the second direction (i.e., the Y-axis direction) and may refer to a reference line extending in the first direction (i.e., the X-axis direction).

The plurality of lifting parts L may be symmetrically arranged with respect to the center line C of the lower plate 21 in the width direction (i.e., the Y-axis direction), thereby supporting the electrode assembly 1000 in a balanced manner to be prevented from being tilted to any one side.

For example, the plurality of lifting parts L may include a first lifting part L1 positioned between the first bars 100a and 100b and a second lifting part L2 positioned outside the first bars 100a and 100b.

The first lifting part L1 and the second lifting part L2 may both support inner and outer sides of the electrode assembly 1000. Accordingly, the electrode assembly 1000 may be stably supported. The inner side of the electrode assembly 1000 may refer to a portion of the electrode assembly 1000 disposed between the first bars 100a and 100b when the electrode assembly 1000 is disposed on the first gripper 100, and the outer side of the electrode assembly 1000 may refer to a portion of the electrode assembly 1000 disposed outside the first bars 100a and 100b.

According to an embodiment, a width W2 of the lower plate 21 may be greater than a width W1 of the first gripper 100 or a width W3 of the electrode assembly 1000.

As the width W2 of the lower plate 21 is greater than the width W1 of the first gripper 100, the second lifting part L2 may be formed in the lower plate 21. As the second lifting part L2 is formed in the lower plate 21, the electrode assembly 1000 may be stably supported.

As the width W2 of the lower plate 21 is greater than the width W3 of the electrode assembly 1000, the transport part 20 may stably grip the electrode assembly 1000.

As set forth above, the electrode assembly gripper and the electrode assembly transport system including the same according to an embodiment may prevent the misalignment of the electrode plates of the electrode assembly during the manufacturing process of the secondary battery.

The electrode assembly gripper and the electrode assembly transport system including the same according to an embodiment according to an embodiment may prevent the separation of the electrode assembly from the gripper during the manufacturing process of the secondary battery.

Only specific examples of implementations of certain embodiments are described. Variations, improvements and enhancements of the disclosed embodiments and other embodiments may be made based on the present disclosure of this patent document.

What is claimed is:

1. An electrode assembly gripper comprising:
a first gripper on which an electrode assembly is disposed;
a second gripper disposed to face the first gripper; and
a main body including a support portion supporting the first gripper and the second gripper, and a moving portion capable of relatively moving at least one of the first gripper and the second gripper,
wherein the second gripper includes a gripper base connected to the main body, a contact portion capable of being in contact with the electrode assembly, and a hinge part providing a rotational motion to the contact portion.

2. The gripper of claim 1, wherein the hinge part includes a first through-hole formed in the gripper base, a second through-hole formed in the contact portion, and a hinge pin passing through the first through-hole and the second through-hole.

3. The gripper of claim 1, wherein the gripper base includes a groove part providing a space in which the contact portion is disposed.

4. The gripper of claim 1, wherein each of the first gripper and the gripper base includes a C-shaped configuration.

5. The gripper of claim 1, wherein the first gripper includes first bars disposed to be spaced apart from each other, and
the gripper base includes second bars disposed to be spaced apart from each other.

6. The gripper of claim 5, wherein the hinge part is positioned in a central region of the second bars.

7. The gripper of claim 5, wherein a length of each of the first bars and a length of the contact portion are each greater than or equal to a length of the electrode assembly.

8. The gripper of claim 1, wherein the second gripper further includes an elastic part disposed between the gripper base and the contact portion to provide elastic force to the contact portion.

9. The gripper of claim 8, wherein the elastic part includes a plurality of elastic parts, and
the plurality of elastic parts are symmetrically arranged with respect to the hinge part.

10. The gripper of claim 1, further comprising a friction part disposed on one surface of the contact portion and providing a greater frictional force to the electrode assembly than the contact portion.

11. An electrode assembly transport system comprising:
a first gripper on which an electrode assembly is disposed;
a second gripper disposed to face the first gripper;
a main body including a support portion supporting the first gripper and the second gripper, and a moving portion capable of relatively moving at least one of the first gripper and the second gripper; and
a transport part receiving the electrode assembly from the first gripper and the second gripper and transporting the electrode assembly,
wherein the second gripper includes a gripper base connected to the main body, a contact portion capable of being in contact with the electrode assembly, and a hinge part connecting the gripper base to the contact portion.

12. The system of claim 11, wherein the transport part includes a lower plate on which the electrode assembly is disposed and an upper plate gripping the electrode assembly together with the lower plate while the electrode assembly is positioned therebetween.

13. The system of claim 12, wherein a width of the lower plate is greater than a width of the first gripper or a width of the electrode assembly.

14. The system of claim 12, wherein the lower plate includes at least one lifting part structured to move in a direction toward the electrode assembly.

15. The system of claim 14, wherein the at least one lifting part includes a plurality of lifting parts, and
the plurality of lifting parts are symmetrically arranged with respect to a center line of the lower plate in a width direction.

16. The system of claim 15, wherein the first gripper includes first bars disposed to be spaced apart from each other, and
the plurality of lifting parts include a first lifting part positioned between the first bars and a second lifting part positioned outside the first bars.
